(19) United States
(12) Patent Application Publication
(10) Pub. No.: US 2011/0007134 A1
(43) Pub. Date: Jan. 13, 2011

(54) SYNCHRONIZING VIDEO IMAGES AND THREE DIMENSIONAL VISUALIZATION IMAGES

(75) Inventors: Nicholas W. Knize, Rockwall, TX (US); Roberto Reta, Richardson, TX (US); Larry J. Johnson, Sachse, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/501,785

(22) Filed: Jul. 13, 2009

(51) Int. Cl. H04N 13/00

(52) U.S. Cl. 348/43

(57) ABSTRACT

In accordance with a particular embodiment of the invention, a video frame comprising an image may be synchronized with a context area generated by a three-dimensional visualization tool. The context area may be selected according to location information identifying a location shown in the video frame. The video frame may be overlaid on the context area substantially at the location shown in the video frame to yield a synchronized image that may be displayed on a display.

### RELATED APPLICATIONS

This application is related to U.S. patent application Ser. No. ______, entitled “EXTRACTION OF REAL WORLD POSITIONAL INFORMATION FROM VIDEO,” Attorney's Docket 064747.1327; to U.S. patent application Ser. No. ______, entitled “DISPLAYING SITUATIONAL INFORMATION BASED ON GEOSPATIAL DATA,” Attorney's Docket 064747.1328; and to U.S. patent application Ser. No. ______, entitled “OVERLAY INFORMATION OVER VIDEO,” Attorney's Docket 064747.1329, all filed concurrently with the present application.

### TECHNICAL FIELD

The present disclosure relates generally to image displays, and more particularly to synchronizing video images and three dimensional visualization images.

### BACKGROUND

Videos may provide a viewer with information. However, the information provided by a video may be limited to the perspective of the device, such as a camera, that captures the video.

### SUMMARY OF EXAMPLE EMBODIMENTS

In accordance with a particular embodiment of the invention, a video frame comprising an image may be synchronized with a context area generated by a three-dimensional visualization tool. The context area may be selected according to location information identifying a location shown in the video frame. The video frame may be overlaid on the context area substantially at the location shown in the video frame to yield a synchronized image that may be displayed on a display.

Certain embodiments of the present invention may provide various technical advantages. A technical advantage of one embodiment may include the capability to provide context to a scene depicted by a video. In some embodiments, the context may be provided by expanding the field of view displayed. For example, the view may be expanded by synchronizing a three-dimensional visualization image to the geographical location depicted by the video. The additional context may provide advantages in situational awareness applications. For example, the additional context may aid military users in obtaining intelligence and/or in making tactical decisions.

Although specific advantages have been enumerated above, various embodiments may include all, some, or none of the enumerated advantages. Additionally, other technical advantages may become readily apparent to one of ordinary skill in the art after review of the following figures and description.

### BRIEF DESCRIPTION OF THE DRAWINGS

For a more complete understanding of certain embodiments of the present invention and features and advantages thereof, reference is now made to the following description taken in conjunction with the accompanying drawings, in which:

FIG. 1 illustrates an embodiment of a display that may synchronize video images with three dimensional visualization images; and

FIG. 2 is a block diagram illustrating a method for synchronizing video images with three dimensional visualization images.

### DETAILED DESCRIPTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

Videos may provide a viewer with information. However, the information provided by a video may be limited to the perspective of the device, such as a camera, that captures the video. A viewer may want to view additional information that may provide context to the video. For example, a viewer may want to view an area surrounding the location shown in the video. Accordingly, teachings of certain embodiments synchronize a three-dimensional visualization image to the location shown in the video to provide context for the video.

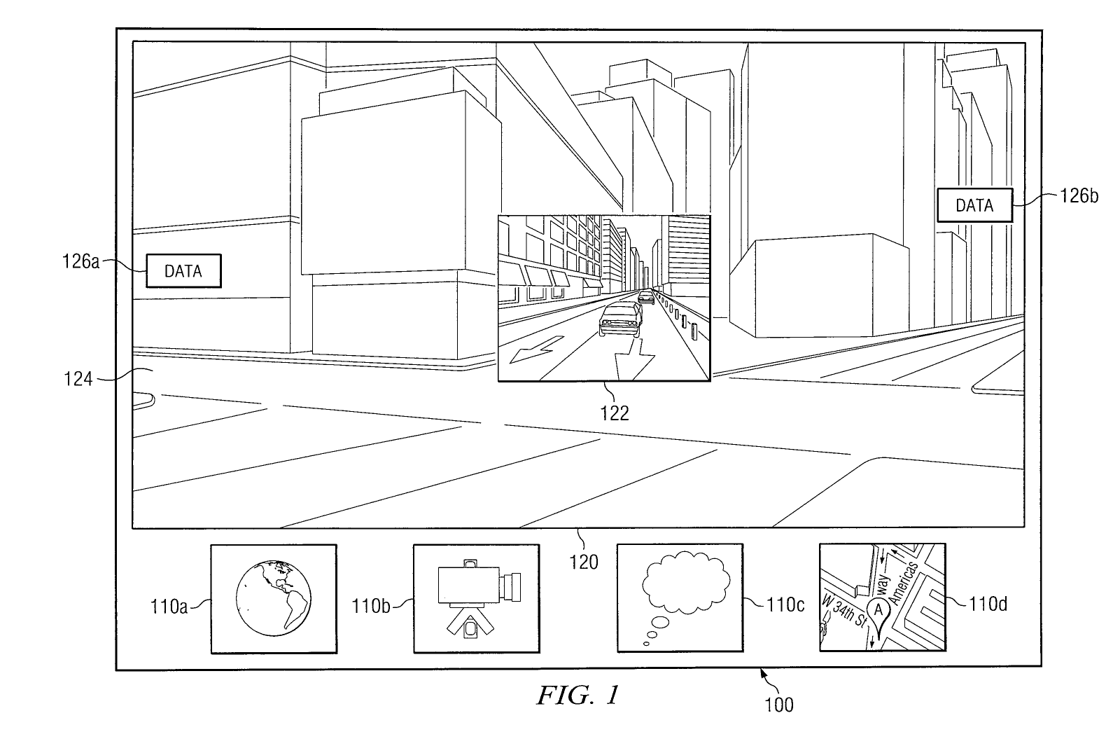

FIG. 1 illustrates an embodiment of a display that may synchronize video images with three-dimensional visualization images. In some embodiments the display may be generated on a device 100 which may comprise feature buttons 110 and a display screen 120. In some embodiments, the display screen 120 may comprise a video frame 122, a context area 124, and/or one or more geotags 126.

The device 100 may be any suitable device for displaying an image. In some embodiments, the device 100 may be portable. For example, the device 100 may be a mobile phone, goggles, or a laptop computer. In other embodiments, the device 100 may not be portable. The device 100 may be configured to provide a variety of features. In some embodiments, a user may access and/or control the features of the device 100 through the feature buttons 110. The feature buttons 110 may be any suitable user interface for the device 100, such as a keyboard or keypad, a mouse, or a touch screen. In some embodiments, the feature buttons 110 may be located remotely from the device 100.

The feature buttons 110 may provide access to and/or a control interface for one or more features such as internet features, mapping features, tracking features, communications features, video features, global visualization features, and/or any other suitable feature. Internet features may include internet browsing as well as downloading and uploading of data. Mapping features may be configured to provide maps and travel directions to a user. Tracking features may include tracking one or more moving subjects or objects. For example, in military applications, members of allied troops may be tracked in one color and members of enemy troops may be tracked in a different color. Communications features may provide voice call, text messaging, chat session, and notification capabilities. Video features may include recording, playing, pausing, fast forwarding, and rewinding of video. Global visualization features may allow a user to select a location of the globe to be represented in a three-dimensional view. In some embodiments, an application may use capabilities of multiple feature buttons 110 at the same time. For example, a video synchronization application may use the video feature, the global visualization feature, and/or any other suitable feature simultaneously.

In some embodiments, one or more features may generate a display on the display screen 120. In some embodiments, the display screen 120 may be any component suitable to display an image such as a Cathode Ray Tube (CRT), a Liquid Crystal Display (LCD), a Plasma Display Panel (PDP), or a projector. In some embodiments, the display screen 120 may be a touch screen that may allow a user to control the image or the device 100. For example, the user may control the image by touching the display screen 120 to make changes such as zooming in or out, moving the image up, down, left, or right, rotating the image, or adjusting the viewing angle. As another example, the feature buttons 110 may be integrated on the display screen 120 and therefore may allow the user to control the device 100 by touching the display screen 120. In some embodiments, the display screen 120 may be configured to change the image displayed according to changes in the position and/or viewing angle of the device 100. In some embodiments, the display screen 120 may display a synchronized image that synchronizes the video frame 122 and the context area 124 according to geographical location. As additional video frames 122 are received, the context area 124 and the synchronized image may be updated to reflect movements and changes from one video frame 122 to the next.

In some embodiments, the video frame 122 may be a single frame of a video stream. The video frame 122 may be obtained from any suitable source. For example, the video stream comprising the video frame 122 may be obtained in real-time from a live feed, or it may be obtained from a storage medium that holds previously recorded video. In some embodiments, the video frame may comprise an image that depicts a particular geographical location. In some embodiments, the geographical location may be determined based on metadata corresponding to the video frame 122. Metadata may be collected in suitable manner. For example, metadata may be collected by a device capable of simultaneously recording video and metadata. As another example, one device may record the video and another device may record the metadata to be synchronized with the video. In some embodiments, metadata may be recorded for each pixel of the video frame 122. Metadata may be recorded for a pixel according to [Attorney Docket 004578.1320] or any suitable method.

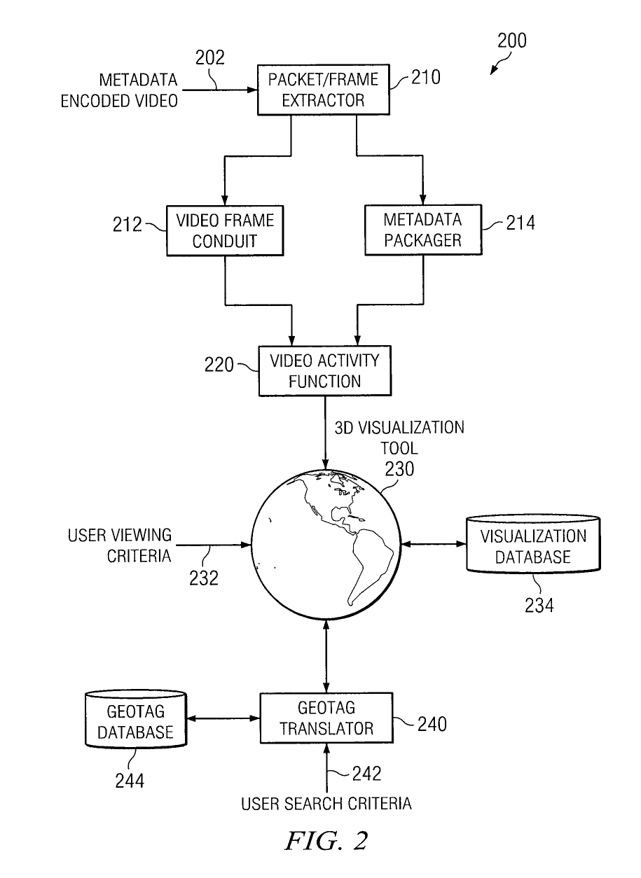

According to some embodiments, the video frame 122 may be overlaid on a global visualization image synchronized to the geographical location shown in the video frame 122. For example, the video frame 122 may be overlaid on the context area 124. The context area 124 may be selected based on the location depicted in the video frame 122. For example, the geographical coordinates of the depicted location may be entered into a three-dimensional visualization tool configured to provide three-dimensional visualization images. In some embodiments, the three-dimensional visualization tool may be a commercial off the shelf (COTS) tool like Google Earth or NASA World Wind. The context area 124 may be selected to provide context to the video frame 122. For example, the context area 124 may comprise the location shown in the video frame 122 and an area surrounding the location shown in the video frame 122. In some embodiments, a user may use the capabilities of the three-dimensional visualization tool to obtain additional context about the location shown in the video frame 122. The capabilities of the three-dimensional visualization tool will be described in more detail with respect to FIG. 2.

In some embodiments, the display screen 120 of the device 100 may display one or more geotags 126 to provide situational information about the displayed image. The geotags 126 may be in any format suitable to convey the situational information. For example, the geotags 126 may be in visual form, such as text, icons, photographs, color codes, and/or drawings, audio form, such as voice recordings or sound effects, or a combination, such as video. In some embodiments, the geotags 126 may comprise geographic coordinates that indicate a location corresponding to the geotag. In some embodiments, the geographic coordinates may indicate the latitude, longitude, and/or elevation described by the situational information. For example, if the situational information indicates that an IED exploded, the geographic coordinates may indicate where the IED exploded. The geotags 126 may be overlaid on the video frame 122 and/or the context area 124. For example, the geotags may be overlaid according to their geographic coordinates. Geotags may be generated using any suitable method, device, or technique that places coordinates on a piece of information. The coordinates may be two-dimensional, three-dimensional, or four-dimensional (including time). As a non-limiting example, geotags may be generated using the method of [Attorney Docket 064747.1329] to generate geotags.

In some embodiments, the geotags 126 may comprise social network geotags, historical geotags, identification geotags, annotation geotags, or a combination. For example, social network geotags may indicate social opinion information like where to find the best coffee in town, social relationship information like a shop owner's brother is a military detainee, social observation information like a sniper has been observed in a particular location, or any other information available through a social network.

Historical geotags may provide historical information such as the number of Improvised Explosive Devices (IEDs) that detonated in the area in the last month.

Identification geotags may provide identification information. For example, an identification geotag may identify an orphanage one hundred yards away. As another example, an identification geotag may translate Grid Reference Graphics (GRG) information. GRG information may provide a naming convention for describing a location. The GRG information may comprise a name that denotes a particular building, a color that denotes a floor number of the building, and a number that denotes an entrance of the building. For example, a soldier may receive GRG information “Matilda, green, 2” indicating the location of a sniper. However, understanding this GRG information may require knowledge of the naming convention. In some embodiments, the geotags 126 may provide the information of the GRG reference without requiring the user to know the GRG naming convention. Thus, the soldier may be able to visualize where the sniper is located and/or the sniper's shooting angle when deciding how to safely approach the building.

Annotation geotags may comprise notes that a user makes about a scene. For example, a user may annotate the background image 124 using a grease pen function that allows the user to draw or write on the display screen 120 by hand or a computerized annotation function that allows a user to select descriptive icons, labels, or color codes to be incorporated into the underlying scene at the option of the user.

In some embodiments, the geotags 126 may be given a rating. For example, determining where to find the best coffee in town may be based on the highest percentage of favorable ratings according to a large number of users. As another example, ratings may be affected by the date and time the geotag 126 was generated. For example, more current geotags may be given a more favorable rating than older geotags. In some embodiments, a rating system may help to ensure a user is provided access to more informative geotags. For example, if a first geotag is a photograph with a clear view and a second geotag is a blurry photograph of the same view, the first geotag may be given a more favorable rating.

A component described in FIG. 1 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible media and may perform operations when executed by a computer. Certain logic, such as a processor, may manage the operation of a component. Examples of a processor include one or more computers, one or more microprocessors, one or more applications, and/or other logic.

In particular embodiments, the operations of the embodiments may be performed by one or more computer readable media encoded with a computer program, software, computer executable instructions, and/or instructions capable of being executed by a computer. In particular embodiments, the operations of the embodiments may be performed by one or more computer readable media storing, embodied with, and/or encoded with a computer program and/or having a stored and/or an encoded computer program.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to systems described herein without departing from the scope of the invention. The components of the systems may be integrated or separated. Moreover, the operations of the systems may be performed by more, fewer, or other components. Additionally, operations of the systems may be performed using any suitable logic comprising software, hardware, and/or other logic. As used in this document, “each” refers to each member of a set or each member of a subset of a set.

FIG. 2 is a block diagram illustrating a method 200 for synchronizing video images and three-dimensional visualization images.

According to some embodiments, the method 200 may begin by sending metadata encoded video 202 to a packet frame extractor 210. Metadata encoded video 202 may be a video stream comprising a plurality of encoded video frames. The video stream may be a previously recorded video or a live feed received in real-time. In some embodiments, the metadata of the metadata encoded video 202 may comprise embedded information like the time the video was taken, the location shown in the video, and/or the camera type used to take the video. In some embodiments, the method may iterate each time a video frame of the video stream is received. Thus, the synchronized image generated by the method may be continually updated to display the location shown in the current video frame. The user may use video features to obtain additional information about a video frame of interest. For example, a user may rewind the video, pause the video on a particular frame, or play the video in slow motion.

Upon receipt of a frame of the metadata encoded video 202, the packet frame extractor 210 may analyze the encoded video frame for specific byte combinations, such as metadata headers, that indicate the presence of metadata. When the packet frame extractor 210 detects metadata, it may perform an extraction function that separates the video frame and the raw metadata. In some embodiments the video frame may be like the video frame 122 of FIG. 1, and it may comprise the underlying video stripped of metadata. After performing the extraction function, the packet frame extractor 210 may send the video frame to a video frame conduit 212 to be displayed and/or to be passed to another function. In some embodiments, the packet frame extractor 210 may send the raw metadata to a metadata packager 214 to be formatted in a form that may be used by other programs.

According to some embodiments, the video frame conduit 212 may send the video frame to a video activity function 220. Upon receipt of the video frame, the video activity function 220 may request location information for the video frame from the metadata packager 214. The metadata packager 214 may reply to the request with location information based on the metadata corresponding to the video frame. The location information may include latitude information, longitude information, azimuth information, compass direction information, elevation information, and/or any other type of information suitable for geographically locating the image of the corresponding video frame.

According to some embodiments, the video activity function 220 may pass the location information to a three-dimensional visualization tool 230. For example, the three-dimensional visualization tool 230 may use the location information to generate a context area such as the context area 124 of FIG. 1. The context area generated by the three-dimensional visualization tool 230 may be synchronized to the location shown in the video frame. That is, the context area may comprise the location shown in the video and an area surrounding the location shown in the video.

In some embodiments, the context area may be refined by a user of the three-dimensional visualization tool 230. For example, the three-dimensional visualization tool 230 may accept user viewing criteria 232. In some embodiments, the user viewing criteria 232 may allow the user to modify the perspective of the view by accessing features of a COTS three-dimensional visualization tool such as Google Earth or NASA World Wind. For example, the user may be able to zoom in or zoom out of the area surrounding the location shown in the video, shift the image up, down, left, or right, change the compass direction, or change the viewing angle. Refining the context area according to the user viewing criteria 232 may provide the user with contextual information that would not be available if the video were viewed on its own. For example, if a video shows a car driving through an open field, the context area may be zoomed out to show where the car is going, what roads are located nearby, the fact that a safe house is a fifty yards away, or any other contextual information. As another example, if the car shown in the video turns to the left, the three-dimensional visualization tool 230 may allow the user to also see what is on the right.

According to some embodiments, the user viewing criteria 232 may also comprise any criteria that may be entered into the three-dimensional visualization tool 230. For example, the user viewing criteria 232 may request that information be displayed such as geographic borders, names of geographic locations, names of landmarks, or street locations and names. The user viewing criteria 232 may also modify the displayed image to provide more information about the view. For example, buildings may be displayed in a three-dimensional form, photographs of street views may be accessed, or terrain information may be shown. The user viewing criteria 232 may also be used to view current conditions in the area such as traffic and/or weather conditions.

In some embodiments, the three-dimensional visualization tool 230 may be coupled to a database, such as a visualization database 234. According to some embodiments, the visualization database 234 may be a COTS database. The visualization database 234 may hold three-dimensional visualization images depicting a plurality of locations. In some embodiments, the images may comprise satellite images, aerial photography images, Geographic Information System (GIS) images, or a combination. The three-dimensional visualization tool 230 may query the visualization database 234 to obtain images of a particular location.

In some embodiments, the video activity function 220 may send the video frame to be overlaid on the context area of the three-dimensional visualization tool 230. In some embodiments, the video frame may be displayed within the context area according to the location information of the metadata corresponding to the video frame. That is, the video frame may be displayed within the context area substantially at the location shown in the video. In some embodiments, the display may be centered such that the video frame may be displayed substantially in the middle of the display screen.

According to some embodiments, geotags, such as the geotags 126 of FIG. 1, may be overlaid on the video frame and/or the context area displayed by the three-dimensional visualization tool 230. According to some embodiments, a geotag may provide additional context for the video. The geotags may provide different and/or more current information than the information available in the COTS features of the three-dimensional visualization tool 230. For example, a historical geotag may show that a car slowed down in a location where four IEDs had been detonated within the previous month.

In some embodiments, the three-dimensional visualization tool 230 may receive the geotags from a geotag translator 240. The geotag translator 240 may search for geotags and/or may format the search results in a file format that may be used by the three-dimensional visualization tool 230. For example, the geotag translator 240 may format the geotags in keyhole markup language (KML) format or key length value (KLV) format.

In some embodiments, the geotag translator 240 may accept user search criteria 242 to determine the geotags to pass to the three-dimensional visualization tool 230. For example, the user search criteria 242 may specify that the user has requested to see a social geotag indicating where to get a good cup of coffee in the area. In some embodiments, the geotag translator 240 may be coupled to a geotag database 244 configured to receive, store, sort, and/or send geotags. In some embodiments, the geotag database 244 may sort a geotag according to its metadata. For example, the metadata of a geotag may comprise the geographical coordinates corresponding to the information described by the geotag. Thus, when the geotag translator 240 receives the user search criteria 242, it may translate the user search criteria 242 into a database query comprising a metadata query.

In some embodiments, a user generated geotag, such as an annotation geotag, may be pushed to the geotag database 244. Pushing a geotag to the geotag database 244 may cause the geotag to become available as a part of the underlying scene. That is, the geotag database 244 may store the pushed geotag so that the geotag may later be pulled to any suitable device according to the user search criteria 242. The search may be requested by any user authorized to receive the geotag. For example, the user that generated the geotag may belong to a unit comprising a plurality of users that are all authorized to receive the geotag.

Modifications, additions, or omissions may be made to the methods described herein without departing from the scope of the invention. The methods may include more, fewer, or other steps. Additionally, steps may be performed in any suitable order.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke 6 of 35 U.S.C. §112 as it exists on the date of filing hereof unless the words “means for” or “step for” are explicitly used in the particular claim.

What is claimed is:

1. A method comprising:
receiving a video frame, the video frame comprising an image;
receiving location information corresponding to the video frame, the location information identifying a location shown in the video frame;
generating a synchronized image, the synchronized image generated by:
sending the location information of the video frame to a three-dimensional visualization tool to generate a context area, the context area comprising the location shown in the video frame;
overlaying the video frame on the context area substantially at the location shown in the video frame; and
displaying the synchronized image on a display.

2. The method of claim 1, wherein the location information is selected from one or more of the group of information consisting of: latitude information, longitude information, azimuth information, compass direction information, and elevation information.

3. The method of claim 1, the context area further comprising an area surrounding the location shown in the video frame, the area surrounding the location selected to provide context for the video frame.

4. The method of claim 1, the video frame comprising an encoded video frame that has been stripped of metadata.

5. The method of claim 4, the location information derived from metadata of the encoded video frame.

6. The method of claim 1, further comprising overlaying one or more geotags on the display, the geotags configured to describe an item being displayed.

7. The method of claim 6, the geotags selected from the group of geotags consisting of social network geotags, historical geotags, identification geotags, and annotation geotags.

8. The method of claim 1, further comprising:
receiving an annotation on a portion of the synchronized image; and
pushing the annotation to a database, the database configured to pull the annotation from the database upon a request from a user.

9. The method of claim 1, the video frame overlaid substantially in the middle of the display.

10. An apparatus comprising:
logic encoded in a computer readable media, the logic configured to:
receive a video frame, the video frame comprising an image;
receive location information corresponding to the video frame, the location information identifying a location shown in the video frame;
generate a synchronized image, the synchronized image generated by:
sending the location information of the video frame to a three-dimensional visualization tool to generate a context area, the context area comprising the location shown in the video frame;
overlay the video frame on the context area substantially at the location shown in the video frame; and
display the synchronized image on a display.

11. The apparatus of claim 10, wherein the location information is selected from one or more of the group of information consisting of: latitude information, longitude information, azimuth information, compass direction information, and elevation information.

12. The apparatus of claim 10, the context area further comprising an area surrounding the location shown in the video frame, the area surrounding the location selected to provide context for the video frame.

13. The apparatus of claim 10, the video frame comprising an encoded video frame that has been stripped of metadata.

14. The apparatus of claim 13, the location information derived from metadata of the encoded video frame.

15. The apparatus of claim 10, further comprising overlaying one or more geotags on the display, the geotags configured to describe an item being displayed.

16. The apparatus of claim 15, the geotags selected from the group of geotags consisting of social network geotags, historical geotags, identification geotags, and annotation geotags.

17. The apparatus of claim 10, further comprising:
receiving an annotation on a portion of the synchronized image; and
pushing the annotation to a database, the database configured to pull the annotation from the database upon a request from a user.

18. The apparatus of claim 10, the video frame overlaid substantially in the middle of the display.

19. A method comprising:
sending a video frame, the video frame comprising an image;
sending location information corresponding to the video frame, the location information identifying a location shown in the video frame;
receiving a synchronized image, the synchronized image generated by:
sending the location information of the video frame to a three-dimensional visualization tool to generate a context area, the context area comprising the location shown in the video frame;
overlaying the video frame on the context area substantially at the location shown in the video frame; and
displaying the synchronized image on a display.

20. The method of claim 19, wherein the location information is selected from one or more of the group of information consisting of: latitude information, longitude information, azimuth information, compass direction information, and elevation information.

21. The method of claim 19, the context area further comprising an area surrounding the location shown in the video frame, the area surrounding the location selected to provide context for the video frame.

22. The method of claim 19, the video frame comprising an encoded video frame that has been stripped of metadata.

23. The method of claim 22, the location information derived from metadata of the encoded video frame.

24. The method of claim 19, further comprising overlaying one or more geotags on the display, the geotags configured to describe an item being displayed.

25. The method of claim 24, the geotags selected from the group of geotags consisting of social network geotags, historical geotags, identification geotags, and annotation geotags.

26. The method of claim 19, further comprising:
receiving an annotation on a portion of the synchronized image; and
pushing the annotation to a database, the database configured to pull the annotation from the database upon a request from a user.

27. The method of claim 19, the video frame overlaid substantially in the middle of the display.
